(19) United States
(12) Patent Application Publication
(10) Pub. No.: US 2015/0134727 A1
(43) Pub. Date: May 14, 2015

(54) CLOUD-BASED DATA SERVER PROVIDING HOME APPLIANCE MANAGEMENT SERVICE AND METHOD THEREOF

(71) Applicant: Konkuk University Industrial Cooperation Corp., Seoul (KR)

(72) Inventors: Han Ku LEE, Seoul (KR); Myoung Jin KIM, Seoul (KR); Yun CUI, Seoul (KR); Seung Hyun SEO, Gyeonggi-do (KR)

(73) Assignee: KONKUK UNIVERSITY INDUSTRIAL COOPERATION CORP., Seoul (KR)

(21) Appl. No.: 14/092,849

(22) Filed: Nov. 27, 2013

(30) Foreign Application Priority Data
Nov. 12, 2013 (KR) 10-2013-0137009

(51) Int. Cl. H04L 29/08

(52) U.S. Cl. CPC H04L 67/025; H04L 67/1097
USPC 709/203

(57) ABSTRACT

A cloud-based data server providing a user of a terminal apparatus with a management service for one or more home appliances connected to a home gateway through a home network using a cloud storage, and a method thereof performed by the cloud-based data server are provided. By providing the home appliance management service to the user of the terminal apparatus through the cloud-based data server, metadata, associated with the home appliances, generated by the home appliances may be managed efficiently, and the user of the terminal apparatus may remotely monitor states of the home appliances or control functions or operations of the home appliances in a home network system.

### CROSS-REFERENCE TO RELATED APPLICATION

This application claims the benefit of Korean Patent Application No. 10-2013-0137009, filed on Nov. 12, 2013, in the Korean Intellectual Property Office, the disclosure of which is incorporated herein by reference.

### BACKGROUND

1. Field of the Invention

The present invention relates to a method of providing a home appliance management service to a user of a terminal apparatus, and more particularly, to a method of providing a home appliance management service to a user of a terminal apparatus using a cloud-based data server.

2. Description of the Related Art

With the development of digital technology, various methods of monitoring states of digitalized home appliances and controlling functions or operations of the home appliances have been suggested.

A user may monitor states of home appliances or control the home appliances through a network formed among the home appliances in ubiquitous environments. The user may also remotely monitor the states of the home appliances or control the home appliances using a smart device of the user.

Such monitoring and controlling may be preformed based on data, associated with states and/or functions of the home appliances, generated by the home appliances. However, a conventional home appliance management system may not efficiently store, analyze, and process a large amount of data, associated with the states and/or the functions of the home appliances, generated at every unit time.

Accordingly, there is a demand for a system for managing home appliances that may efficiently manage a large amount of data generated by the home appliances. In addition, there is a demand for a system for managing home appliances that may reduce an amount of resources used by the smart device of the user when the user remotely monitors the states of the home appliances or controls the home appliances using the smart device of the user.

The foregoing description is provided only for better understanding. The description may include contents not forming a portion of related arts and not include contents suggested by related arts to those skilled in the art.

### SUMMARY

An aspect of the present invention provides a cloud-based data server providing a home appliance management service to a user of a terminal apparatus, and a method thereof performed by the cloud-based data server.

Another aspect of the present invention also provides a home gateway for managing home appliances using a cloud-based data server, and a method thereof performed by the home gateway.

According to an aspect of the present invention, there is provided a method of providing a home appliance management service, the method performed by a cloud-based data server providing a user of a terminal apparatus with a management service for one or more home appliances connected to a home gateway through a home network using a cloud storage, the method including receiving metadata associated with the one or more home appliances from the home gateway, receiving a request signal with respect to the received metadata from the terminal apparatus, and transmitting the received metadata to the terminal apparatus based on the request signal.

The method may further include receiving control request signal from the terminal apparatus.

The control request signal may correspond to a signal requesting control of a function or an operation of at least one of the one or more home appliances.

The method may further include transmitting, to the home gateway, a control signal to control the function or the operation of the at least one home appliance based on the received control request signal.

The control signal may include a command code controlling the function or the operation of the at least one home appliance.

The metadata may include at least one piece of state information on a state of each of the one or more home appliances, service information related to a function of each of the one or more home appliances, and information on a command code requested to control each of the one or more home appliances.

The method may further include selecting metadata to be transmitted to the terminal apparatus from among the received metadata, based on the received request signal.

The transmitting may include transmitting the selected metadata to the terminal apparatus.

The method may further include extracting detailed information from the received metadata.

The method may further include storing the extracted detailed information in the cloud storage.

The extracting may include extracting the detailed information from the metadata by extracting values of each metadata field.

Metadata to be transmitted to the terminal apparatus may include information selected based on the request signal from among the extracted detailed information.

According to another aspect of the present invention, there is also provided a method of managing a home appliance, the method performed by a home gateway connected to one or more home appliances through a home network, the method including receiving metadata associated with the one or more home appliances from the one or more home appliances, transmitting the received metadata to a cloud-based data server, receiving, from the cloud-based data server, a control signal corresponding to a signal controlling a function or an operation of at least one of the one or more home appliances, and transmitting the received control signal to the at least one home appliance.

The method may further include receiving advertised information from the one or more home appliances.

The method may further include transmitting a metadata request signal to the one or more home appliances based on the advertised information.

The receiving of the metadata may include receiving metadata transmitted based on the metadata request signal from the one or more home appliances.

The receiving of the metadata may include accessing the one or more home appliances to receive the metadata associated with the one or more home appliances from the one or more home appliances.

The one or more home appliances may be connected to the home gateway via a router.

The metadata may include at least one piece of state information on a state of each of the one or more home appliances, service information related to a function of each of the one or more home appliances, and information on a command code requested to control each of the one or more home appliances.

The control signal may include a command code controlling the function or the operation of the at least one home appliance.

According to still another aspect of the present invention, there is also provided a cloud-based data server providing a user of a terminal apparatus with a management service for one or more home appliances connected to a home gateway through a home network using a cloud storage, the data server including a network bridge module (NBM) to receive metadata associated with the one or more home appliances from the home gateway, and a monitoring service module (MSM) to receive a request signal with respect to the metadata from the terminal apparatus, and transmit the received metadata to the terminal apparatus based on the request signal.

The MSM may receive a control request signal from the terminal apparatus.

The control request signal may correspond to a signal requesting control of a function or an operation of at least one of the one or more home appliances.

The MSM may transmit, to the home gateway, a control signal to control the function or the operation of the at least one home appliance based on the received control request signal.

The data server may further include a metadata extraction module (MEM) to extract detailed information from the received metadata.

The extracted detailed information may be stored in the cloud storage.

According to yet another aspect of the present invention, there is also provided a home gateway connected to one or more home appliances through a home network, the home gateway including a device subscription function module (DSFM) to receive metadata associated with the one or more home appliances from the one or more home appliances, a network bridge module (NBM) to transmit the received metadata to a cloud-based data server, and receive a control signal from the cloud-based data server, and an action transmission module (ATM) to transmit the received control signal to at least one of the one or more home appliances. The control signal may correspond to a signal controlling a function or an operation of the at least one home appliance.

The home gateway may further include a device registering function module (DRFM) to receive advertised information from the one or more home appliances.

The DSFM may transmit a metadata request signal to the one or more home appliances based on the advertised information.

The DSFM may receive metadata transmitted based on the metadata request signal from the one or more home appliances.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for providing a home appliance management service according to an embodiment of the present invention;

FIG. 2 is a block diagram illustrating a configuration of a cloud-based data server according to an embodiment of the present invention;

FIG. 3 is a block diagram illustrating a configuration of a home gateway according to an embodiment of the present invention;

FIG. 4 is a diagram illustrating an example of a system for providing a home appliance management service;

FIG. 5 is a signal flowchart illustrating a method of providing a home appliance management service according to an embodiment of the present invention; and

FIG. 6 is a diagram illustrating an example of simulators acting as home appliances.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Though the present invention may be variously modified and have several embodiments, specific embodiments will be shown in drawings and be explained in detail. However, the present invention is not meant to be limited, but it is intended that various modifications, equivalents, and alternatives are also covered within the scope of the claims.

Terms used herein are to merely explain specific embodiments, not meant to limit the scope of the present invention. A singular expression includes a plural concept unless there is a contextually distinctive difference therebetween. In this description, the term “include” or “have” is intended to indicate that characteristics, numbers, steps, operations, components, elements, and the like disclosed in the specification or combinations thereof exist. As such, the term “include” or “have” should be understood that there are additional possibilities of one or more other characteristics, numbers, steps, operations, components, elements or combinations thereof.

Unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined in the present invention, the terms are not interpreted as ideal or excessively formal meanings.

Hereinafter, specific embodiments of the present invention will be explained in more detail with reference to the attached drawings. The same component or components corresponding to each other will be provided with the same reference numeral, and their detailed explanation will be omitted. When it is determined that a detailed description is related to a related known function or configuration which may make the purpose of the present disclosure unnecessarily ambiguous in the description, such a detailed description will be omitted.

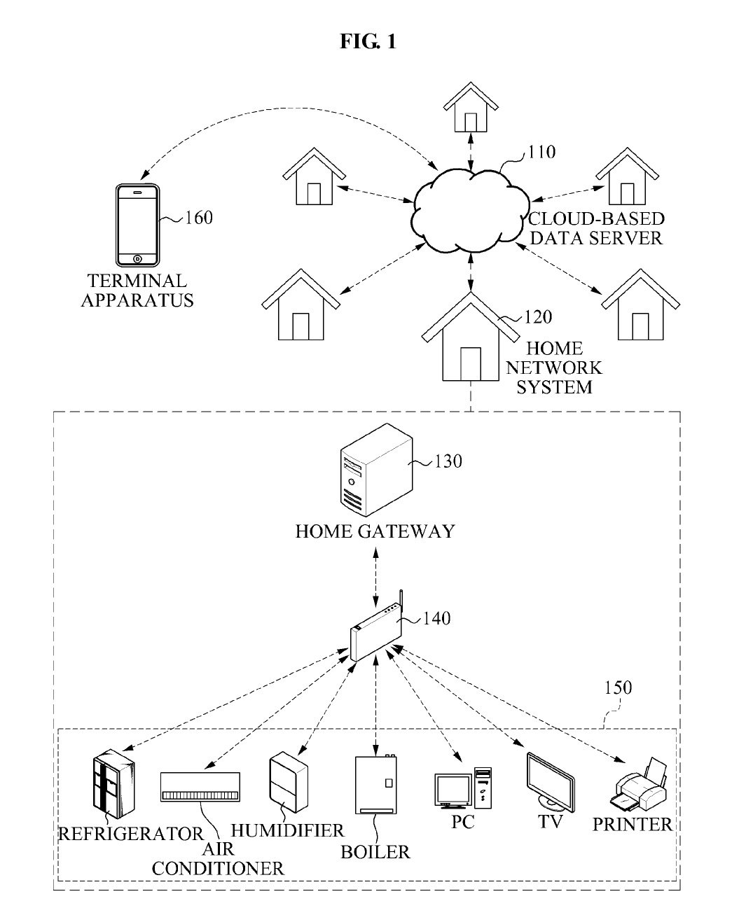

FIG. 1 is a diagram illustrating a system for providing a home appliance management service according to an embodiment of the present invention.

Illustrated is a system in which states of one or more home appliances 150 may be monitored and functions or operations of the home appliances 150 may be controlled, using a terminal apparatus 160 of a user.

The system for managing the home appliances 150 may include a cloud-based data server 110 using a cloud storage, one or more home network systems connected through a network operated by the cloud-based data server 110, and the terminal apparatus 160.

The one or more home network systems may be connected to the cloud-based data server 110 through the network operated by the cloud-based data server 110.

A home network system 120 connected to the data server 110 may include a home gateway 130, a router 140, and the one or more home appliances 150.

The system for managing the home appliances 150 may maintain and store information on the home appliances 150 transmitted through the home gateway 130 using the cloud-based data server 110. In the system for managing the home appliances 150, data and/or information on the home appliances 150 may be transmitted and received among the data server 110, the home gateway 130, and the terminal apparatus 160, whereby a service for managing the home appliances 150 may be provided to the user of the terminal apparatus 160.

The terminal apparatus 160 may include all devices by means of which the service for managing the home appliances 150 may be provided through wired and wireless networks, for example, a personal computer (PC), a laptop computer, a tablet PC, and a smartphone.

The home appliances 150 may refer to electrical devices used at home.

For example, the home appliances 150 may include a refrigerator, an air conditioner, a humidifier, a boiler, a PC, a television (TV), and a printer.

The home appliances 150 may be connected to the home gateway 130 through a home network in wired and wireless fashion. The home network may be established based on universal plug and play (UPnP).

In contrary to the drawing, the home appliances 150 may correspond to at least one of home appliances connected to the home gateway 130 through the home network.

The data server 110 may store, maintain, and manage metadata generated by the home appliances 150. For example, the data server 110 may store and/or manage the generated metadata using a Hadoop Distributed File System (HDFS) of the cloud storage used by the data server 110.

The data server 110 may transmit the generated metadata to the terminal apparatus 160, thereby providing a service for monitoring the home appliances 150 to the user of the terminal apparatus 160. When the user requests metadata associated with at least one home appliance selected from the home appliances 150, the data server 110 may provide a service for monitoring the selected at least one home appliance associated with the requested metadata.

The generated metadata may be transmitted to the data server 110 through the home gateway 130. The home gateway 130 may receive the metadata associated with the home appliances 150 from the home appliances 150, and transfer the received metadata to the data server 110.

The metadata generated by the home appliances 150 may include information on the home appliances 150. For example, the metadata may include at least one piece of state information on a state of each of the home appliances 150, service information related to a function of each home appliance, and information on a command code requested to control each home appliance.

The generated metadata may correspond to data of an extensible mark-up language (XML) format, or the home gateway 130 may convert the received metadata to data of an XML format.

The home gateway 130 may communicate with the home appliances 150 through the home network. The home gateway 130 may be connected to the home appliances 150 in wired and wireless fashion.

The home gateway 130 may communicate with the home appliances 150 to monitor the states of the home appliances 150, collect the metadata from the home appliances 150, and transfer the collected metadata to the data server 110.

The home gateway 130 may be connected to the home appliances 150 using a UPnP function. The home gateway 130 may identify and acquire the metadata generated by the home appliances 150, using the UPnP function. For example, the home gateway 130 may use the UPnP function to identify and acquire at least one piece of service information related to the functions of the home appliances 150, information related to the states of the home appliances 150, and information related to features of the home appliances 150 included in the metadata.

The home appliances 150 may be connected to the home gateway 130 via the router 140. The router 140 may relay transmission and reception of data and/or information between the home gateway 130 and the home appliances 150.

The home gateway 130 may communicate with the data server 110 in wired and wireless fashion. The home gateway 130 may transfer the metadata received from the home appliances 150 to the data server 110 through the network operated by the data server 110.

The home gateway 130 may act as a bridge between the home network and networks operated by the data server 110 across a boundary of the home network and the networks operated by the data server 110.

The metadata transferred from the home gateway 130 may be stored in the cloud storage used by the data server 110. The cloud storage may include a data center. The data center may maintain and manage the metadata transferred from the home gateway 130. For example, the data center may be implemented using the HDFS and MapReduce.

When the metadata managed by the data center is transferred to the terminal apparatus 160, the user of the terminal apparatus 160 may control or monitor the home appliances 150 associated with the metadata. For example, the user of the terminal apparatus 160 may remotely monitor states of the home appliances 150 or control functions or operations of the home appliances 150, using the terminal apparatus 160.

The user of the terminal apparatus 160 may control a function or an operation of at least one of the home appliances 150, using the terminal apparatus 160.

In addition, the user of the terminal apparatus 160 may verify whether the function or the operation of the at least one home appliance is controllable using the terminal apparatus 160.

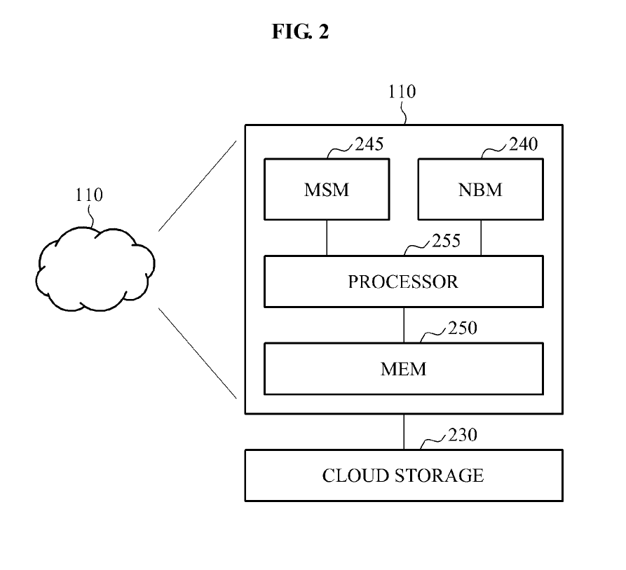

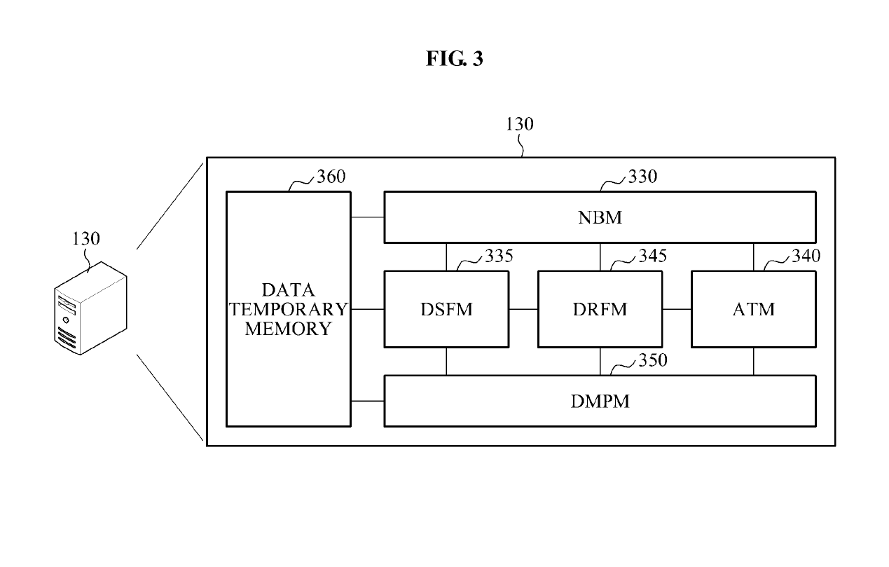

The data server 110 and the home gateway 130 constituting the system for managing the home appliances 150 will be further described in detail with reference to FIGS. 2 and 3.

FIG. 2 is a block diagram illustrating a configuration of the cloud-based data server 110 according to an embodiment of the present invention.

The cloud-based data server 110 may provide a user of the terminal apparatus 160 with a service for managing the one or more home appliances 150 connected to the home gateway 130 through a home network using a cloud storage 230.

As described with reference to FIG. 1, the cloud-based data server 110 may store and manage metadata received from the home gateway 130. In addition, the data server 110 may transfer the received metadata to the terminal apparatus 160.

The data server 110 may include a network bridge module (NBM) 240, a monitoring service module (MSM) 245, a metadata extraction module (MEM) 250, and a processor 255.

The processor 255 may manage components of the data server 110, and execute a program used by the data server 110. The processor 255 may refer to a device configured to process operations required for program execution, data processing, and the like. For example, the processor 255 may correspond to a central processing unit (CPU) of the data server 110. In contrast to the drawing, the modules, for example, the NBM 240, the MSM 245, and the MEM 250, may be a portion of the processor 255. The processor 255 may include at least one processor or at least one core in a processor.

The NBM 240 may refer to a device configured to transmit and receive information and/or data through wired and wireless networks.

The data server 110 may perform bidirectional communication using the NBM 240.

The NBM 240 may include a UPnP bridge. The UPnP bridge may enable the NBM 240 to operate as a host, based on UPnP functional demands.

The data server 110 may transmit and receive data through the NBM 240. For example, the data server 110 may transmit and receive data of an XML format using Hypertext Transfer Protocol (HTTP) through NBM 140.

The NBM 240 may communicate with the home gateway 130 in wired and wireless fashion.

The NBM 240 may receive metadata associated with the home appliances 150 from the home gateway 130. The NBM 240 may communicate with an NBM of the home gateway 130, which will be described later with reference to FIG. 3. The NBM 240 may receive the metadata generated by the home appliances 150 from the NBM of the home gateway 130.

The received metadata may be stored and managed in the HDFS of the cloud storage 230. The metadata stored and managed in the HDFS may be utilized by the MSM 245 and the MEM 250 to provide a monitoring service to the user of the terminal apparatus 160.

The NBM 240 may transfer the received metadata to the MEM 250. The MEM 250 may extract detailed information from the transferred metadata. For example, the MEM 250 may extract detailed information on the home appliances 150 from the metadata, by extracting values of each metadata field. The MEM 250 may extract the detailed information from the metadata, by classifying the metadata as at least one piece of information related to features of the home appliances 150, service information related to functions of the home appliances 150, and information related to states of the home appliances 150.

As described with reference to FIG. 1, the metadata received by the NBM 240 may correspond to data of an XML format.

The MEM 250 may extract detailed information on the home appliances 150 from the data of the XML format. The MEM 250 may extract detailed information of an XML format from the metadata received by the NBM 240.

The MEM 250 may analyze the metadata, and extract the detailed information from the metadata by extracting the values of each metadata field.

The MEM 250 may use Hadoop-based MapReduce to classify data included in the extracted detailed information based on a home appliance corresponding to relevant data. For example, the data included in the extracted detailed information may be classified based on a model name of a home appliance corresponding to relevant data. The MEM 250 may map the data of the extracted detailed information based on a model name of a home appliance transferred along with the extracted detailed information.

The MEM 250 may be implemented using a UPnP function.

The cloud storage 230 may store the detailed information extracted by the MEM 250 from the metadata. When the detailed information on the home appliances 150 is extracted by the MEM 250 from the metadata, data included in the extracted detailed information may be classified based on a home appliance associated with the data included in the extracted detailed information and stored in the cloud storage 230.

The data included in the extracted detailed information may be stored in the HDFS of the cloud storage 230.

When the data is stored in the HDFS, three pieces of duplicated data may be generated. The three pieces of duplicated data may be stored in the HDFS in a distributed manner. By generating three pieces of identical duplicated data, the security of the stored data may be insured. The HDFS may efficiently store and maintain data although the data consistently increases in size.

The data of the extracted detailed information stored in the HDFS may be utilized to provide the user of the terminal apparatus 160 with a service for monitoring the one or more home appliances 150 or controlling the function or the operation of at least one of the home appliances 150.

The MSM 245 may communicate with the terminal apparatus 160 in wired and wireless fashion. The MSM 245 may establish a one-to-one connection with the terminal apparatus 160.

The MSM 245 may receive, from the terminal apparatus 160, a request signal with respect to the metadata received by the NBM 240. When the request signal is received, the metadata stored in the HDFS may be transferred to the MSM 245. The metadata transferred to the MSM 245 may correspond to the detailed information extracted by the MEM 250.

The request signal may correspond to a signal requesting metadata associated with the at least one home appliance selected by the user of the terminal apparatus 160 from among the home appliances 150, among the metadata received by the NBM 240. The selected at least one home appliance may refer to at least one home appliance to be monitored or of which a function or an operation is to be controlled, by the user using the terminal apparatus 160.

The MSM 245 may select metadata to be transmitted to the terminal apparatus 160 from among the metadata received by the NBM 240, based on the received request signal.

The MSM 245 may transfer the received metadata to the terminal apparatus 160 based on the request signal received from the terminal apparatus 160. The metadata to be transmitted to the terminal apparatus 160 may correspond to the metadata selected by the MSM 245.

The MSM 245 may acquire the metadata associated with the selected at least one home appliance from the received metadata and/or the detailed information extracted from the received metadata. For example, the MSM 245 may extract, using MapReduce, desired metadata from the metadata received by the NBM 240 and/or the detailed information extracted from the received metadata.

The MSM 245 may transfer the acquired metadata to the terminal apparatus 160. The metadata transferred to the terminal apparatus 160 may correspond to the information selected by the MSM 245 based on the request signal from among the extracted detailed information.

For example, the metadata may correspond to data of a text format, and may be transferred to the terminal apparatus 160 using HTTP.

The user of the terminal apparatus 160 may monitor states of the home appliances 150 using the terminal apparatus 160 based on the received metadata.

The MSM 245 may receive, from the terminal apparatus 160, a control request signal requesting control of a function or an operation of at least one of the home appliances 150.

The control request signal may correspond to a signal requesting control of a function or an operation of at least one home appliance selected by the user of the terminal apparatus 160 from among the home appliances 150. The control request signal may be based on an input with respect to the terminal apparatus 160 provided by the user of the terminal apparatus 160.

The control request signal received by the MSM 245 may include a command code requesting the control of the function or the operation of the selected at least one home appliance.

The MSM 245 may generate a control signal to control a function or an operation of at least one of the home appliances 150, based on the received control request signal. The at least one home appliance may correspond to at least one home appliance selected by the user of the terminal apparatus 160. For example, the MSM 245 may generate the control signal to control the function or the operation of the selected home appliance corresponding to the received control request signal.

The MSM 245 may transmit the generated control signal to the home gateway 130 through the NBM 240. The MSM 245 may extract, from the control request signal, control information on the function or the operation of the selected at least one home appliance. The information may be extracted using MapReduce.

The MSM 245 may transmit the extracted control information, as a control signal, to the home gateway 130 through the NBM 240. The NBM 240 may transfer the control signal to an NBM of the home gateway 130.

For example, the MSM 245 may operate as an interface for providing the user of the terminal apparatus 160 with a service for managing the home appliances 150.

The descriptions provided with reference to FIG. 1 may apply to the foregoing and thus, duplicated descriptions will be omitted for conciseness.

FIG. 3 is a block diagram illustrating a configuration of the home gateway 130 according to an embodiment of the present invention.

The home gateway 130 may refer to a device for readily controlling functions or operations of the home appliances 150 and collecting metadata about the home appliances 150 through a home network.

As described with reference to FIGS. 1 and 2, the home gateway 130 may be connected to the home appliances 150 through the home network, and exchange data with the home appliances 150 connected to the home gateway 130 through the home network. For example, the home gateway 130 may identify metadata associated with the home appliances 150, and receive the metadata associated with the home appliances 150 from the home appliances 150.

The received metadata associated with the home appliances 150 may be transferred to the data server 110 through the home gateway 130.

The home gateway 130 may operate as a bridge between the home network and a network operated by the data server 110.

The home network may be established based on a UPnP.

The home gateway 130 may include an NBM 330, a device subscription function module (DSFM) 335, an action transmission module (ATM) 340, a device registering function module (DRFM) 345, a device metadata parsing module (DMPM) 350, and a data temporary memory 360.

The DRFM 345 may include a basic function provided by the UPnP.

The DRFM 345 may receive advertised information from the home appliances 150. The advertised information may refer to information on functions and/or features of the home appliances 150 connected to the home gateway 130 through the home network. The DRFM 345 may identify and collect the information on the functions and/or the features of the home appliances 150.

The advertised information received by the DRFM 345 may correspond to metadata about the home appliances 150.

The DRFM 345 may use, for example, a simple service discovery protocol (SSDP) to identify and collect service information, related to the functions and/or the features, generated by the home appliances 150 in the home network. The SSDP may refer to a network protocol for advertising and identifying service information related to the functions and/or the features of the home appliances 150 present in the home network using hypertext transfer protocol unicast (HTTPU).

The SSDP may be used by a home appliance in the home network to inform another home appliance present in the home network of service information related to a function and/or a feature of the home appliance.

The SSDP of the DRFM 345 may be used to collect the metadata from the home appliances 150. For example, when the home gateway 130 collects the metadata from the home appliances 150, the SSDP may adopt a multicast mechanism so that the metadata may be identified via port 1900 at all times.

The identified metadata may be stored in a temporary storage space of the DRFM 345 for use by the DSFM 335 and the ATM 340 in the future.

The advertised information received by the DRFM 345 may include basic information on the home appliances 150. For example, the received advertised information may include device types, friendly names, model descriptions, model names, model numbers, unique device names (UDNs), and model uniform resource locators (URLs) of the home appliances 150 collected by the DRFM 345.

Based on the basic information on the home appliances 150 included in the advertised information received by the DRFM 345, the DSFM 335 may request more detailed information on a home appliance associated with the basic information.

The DRFM 345 may identify the received advertised information. For example, the DRFM 345 may identify the received advertised information, thereby identifying the home appliances 150 having transmitted the advertised information.

The DRFM 345 may select at least one home appliance of which more detailed information is to be requested, from among the home appliances 150 based on the received advertised information.

The DSFM 335 may transmit a metadata request signal to the home appliances 150 based on the received advertised information. The DSFM 335 may transmit a metadata request signal to the selected at least one home appliance. The metadata request signal may correspond to a signal requesting more detailed information on a home appliance associated with the basic information included in the advertised information. The home appliances 150 may transmit metadata to the DSFM 335 based on the metadata request signal transmitted by the DSFM 335.

The DSFM 335 may receive the metadata associated with the home appliances 150 from the home appliances 150. The received metadata may correspond to more detailed information on a home appliance associated with the basic information included in the advertised information.

The metadata may be transmitted from the home appliances 150 based on the metadata request signal transmitted by the DSFM 335 to the home appliances 150. The metadata received by the DSFM 335 may correspond to data of an XML format.

The DSFM 335 may access the home appliances 150 based on the received advertised information. The DSFM 335 may access URLs of the home appliances 150 using a subscription command provided by the UPnP.

The DSFM 335 may access the home appliances 150 to receive the metadata associated with the home appliances 150 from the home appliances 150. The DSFM 335 may access the URLs of the home appliances 150 to receive the metadata associated with the home appliances 150.

The home appliance 150 accessed by the DSFM 335 may refer to at least one home appliance selected from among the home appliances 150 based on the advertised information received by the DSFM 335 and/or the metadata request signal transmitted by the DSFM 335.

The metadata received by the DSFM 335 may include at least one piece of state information on a state of each of the home appliances 150, service information related to a function of each home appliance, and information on a command code requested to control each home appliance.

The DRFM 345 may be implemented by a general event notification architecture (GENA) that provides a state alarm function based on HTTP. The DSFM 335 may receive metadata associated with the home appliances 150 from the home appliances 150 through the GENA.

The received metadata may be stored in the data temporary memory 360.

The NBM 330 may communication with the data server 110 in wired and wireless fashion. The NBM 330 may communication with the NBM 240 of the data server 110. For example, the communication between the NBM 330 and the NBM 240 of the data server 110 may be performed using HTTP.

Data exchanged between the home gateway 130 and the data server 110 may correspond to data of an XML format. In UPnP based data communication, the XML format may be used as a medium for transmitting data. HTTP may be used as a protocol for transmitting data.

The home gateway 130 and the data server 110 may communicate with each other using data of an XML format.

The DMPM 350 may extract metadata associated with at least one of the home appliances 150 from the metadata, associated with the home appliances 150, received from the home appliances 150. For example, the DMPM 350 may extract necessary information from the metadata of an XML format. The DMPM 350 may parse the metadata of the XML format received by the NBM 330 using HTTP, and extract, from the metadata, at least one of a type, a model name, and a URL of each of the home appliances 150.

The extracted information may be stored in the data temporary memory 360 or a temporary storage space included in the DMPM 350. The extracted information may be used immediately by another module, for example, the NBM 330, the DSFM 335, the ATM 340, or the DRFM 345. The extracted information may be a portion of the metadata received by the NBM 330.

The NBM 330 may transfer the metadata received from the home appliances 150 to the data server 110. The received metadata may be transferred to the NBM 240 of the data server 110. The metadata transmitted to the data server 110 may correspond to a portion of the metadata received by the NBM 330, for example, the information extracted by the DMPM 350.

The NBM 330 may receive, from the data server 110, a control signal to control a function or an operation of at least one of the home appliances 150. The received control signal may correspond to the control signal generated based on the control request signal received by the MSM 245 from the terminal apparatus 160, as described with reference to FIG. 2. The control signal received by the NBM 330 may include command codes for controlling the function or the operation of at least one of the home appliances 150.

For example, the NBM 330 may operate as a networking bridge between the home network and a network operated by the data server 110.

The ATM 340 may transmit the control signal received by the NBM 330 to at least one home appliance of which a function or an operation is controllable by the control signal, among the home appliances 150. For example, the transmitted control signal may include a command code to control a function or an operation of at least one home appliance selected by the user of the terminal apparatus 160 from among the home appliances 150.

The ATM 340 may utilize the metadata received by the DSFM 335 and/or the advertised information received by the DRFM 345 to transmit the control signal to at least one of the home appliances 150. For example, the ATM 340 may access at least one of the home appliances 150 using information provided by the DRFM 345, thereby transmitting the control signal to the at least one home appliance. The information provided by the DRFM 345 and used by the ATM 340 to access the home appliance may include at least one of URLs, UDNs, and model names of the home appliances 150. The ATM 340 may transfer a control signal including a command code to control a function or an operation of a home appliance to the home appliance, thereby controlling the function or the operation of the home appliance.

The ATM 340 may transmit the control signal to at least one of the home appliances 150 using simple object access protocol (SOAP). SOAP may refer to a protocol which facilitates exchange of XML messages using HTTP, hypertext transfer protocol secure (HTTPS), or simple mail transfer protocol (SMTP). For example, SOAP may refer to a protocol for transferring data and commands in an HTTP-based environment. SOAP may be used as a mechanism for transferring commands in UPnP. SOAP may refer to an underlying protocol used for transferring basic messages in web services. In SOAP, there may be several types of message patterns. In general, SOAP may use a remote procedure call (RPC) to exchange messages. When the RPC is used, a network node, for example, a client, may transmit a request message to another node, for example, a server. The server may immediately respond to the received request message. SOAP may be designed with a design pattern combining a header and a body, which may be implemented in an XML format.

The user of the terminal apparatus 160 may remotely control an operation of at least one of the home appliances 150.

The data server 110 may provide the user of the terminal apparatus 160 with a service for managing the home appliances 150, using the received metadata.

The descriptions provided with reference to FIGS. 1 and 2 may apply to the foregoing and thus, duplicated descriptions will be omitted for conciseness.

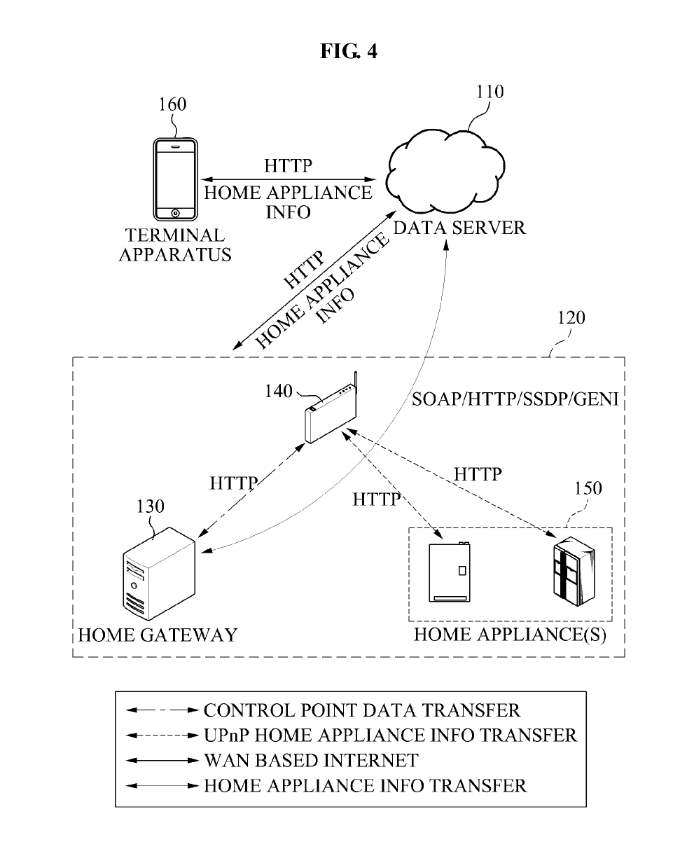

FIG. 4 is a diagram illustrating an example of a system for providing a home appliance management service.

As described with reference to FIGS. 1 through 3, a home network system may include the home gateway 130, the router 140, and the one or more home appliances 150. The router 140 may relay connection between the home gateway 130 and the home appliances 150.

Transmission and reception of data and information among the data server 110, the home gateway 130, the router 140, the home appliances 150, and the terminal apparatus 160 may be performed using HTTP.

The home appliances 150 may transmit metadata to the home gateway 130 via the router 140.

Transmission and reception of data and information between the router 140 and the home appliances 150 may be performed through a UPnP based home network. For example, the home appliances 150 may transmit the metadata associated with the home appliances 150 to the router 140 through the UPnP based home network.

Transmission and reception of data and/or information between the home gateway 130 and the router 140 may be performed through control point data transfer. The home gateway 130 may receive the metadata associated with the home appliances 150 from the router 140.

Transmission and reception of data and/or information among the home gateway 130, the data server 110, and the terminal apparatus 160 may be performed through a wide area network (WAN) based Internet.

The home gateway 130 may transmit the metadata associated with the home appliances 150 to the data server 110. The metadata transmitted by the home gateway 130 to the data server 110 may include state information related to states of the home appliances 150. The data server 110 may transfer the received metadata to the terminal apparatus 160.

The user of the terminal apparatus 160 may monitor the states of the home appliances 150 using the terminal apparatus 160 based on the received metadata.

The user of the terminal apparatus 160 may transmit, to the data server 110 using the terminal 160, a control request signal requesting control of a function or an operation of at least one of the home appliances 150. The data server 110 may transmit a control signal to the home gateway 130 based on the received control request signal. The control signal may refer to a signal generated by the data server 110 based on the received control request signal to control the function or the operation of at least one home appliance selected by the user of the terminal apparatus 160 from among the home appliances 150. The home gateway 130 may transfer, via the router 140, the received control signal to at least one home appliance of which a function or an operation is desired by the user of the terminal apparatus 160 to be controlled.

For example, the user of the terminal apparatus 160 may monitor the states of the home appliances 150, and control the function or the operation of at least one of the home appliances 150, using the terminal apparatus 160.

The descriptions provided with reference to FIGS. 1 and 3 may apply to the foregoing and thus, duplicated descriptions will be omitted for conciseness.

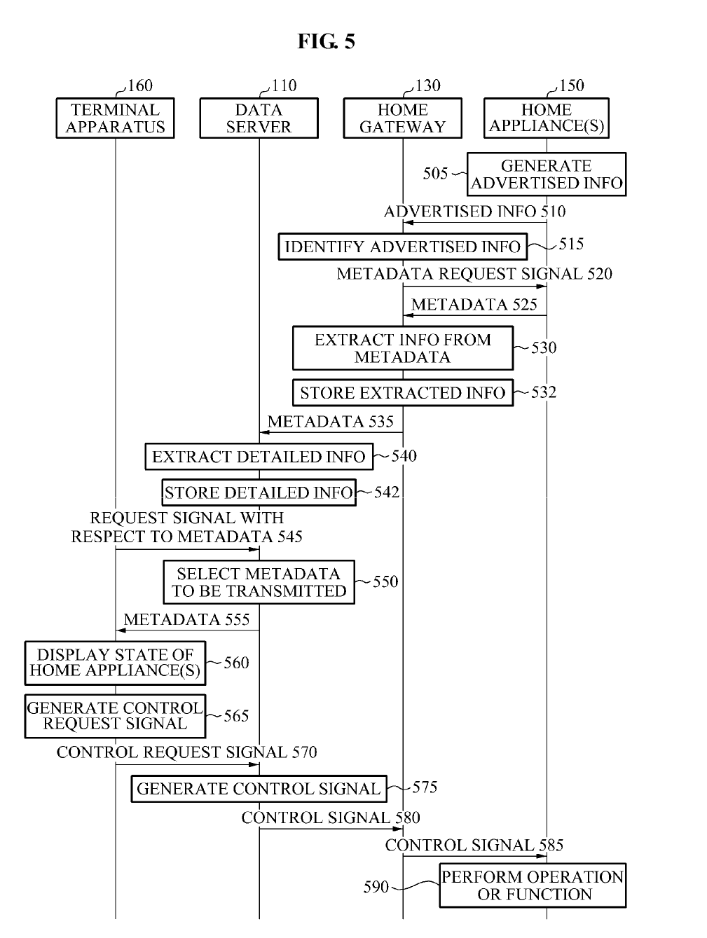

FIG. 5 is a signal flowchart illustrating a method of providing a home appliance management service according to an embodiment of the present invention.

The signal flowchart illustrates transmission and reception of data and/or information among the data server 110, the home gateway 130, the home appliances 150, and the terminal apparatus 160, as described with reference to FIGS. 1 through 4.

In operation 505, each of the home appliances 150 may generate information associated with each home appliance. The information generated by each home appliance may include advertised information, and information related to a current state of each home appliance. The information generated by each home appliance may correspond to metadata associated with each home appliance.

The advertised information generated by each home appliance may include, for example, service information related to a function and/or a feature of each home appliance. The information related to the function and/or the feature of each home appliance may correspond to service information related to a function and/or a feature of each home appliance determined by a manufacturer or a seller of each home appliance.

The information related to the current state of each home appliance may correspond to information generated by a sensor included in each home appliance. A type of the sensor included in each home appliance may vary depending on types of the home appliances 150.

The sensor included in each home appliance may meet predetermined criterion associated with a function or an operation of each home appliance.

The sensor included in each home appliance may generate information related to a state of each home appliance, rather than the service information related to the function and/or the feature of each home appliance predetermined by each home appliance. The information, related to the state of each home appliance, generated by the sensor may be utilized for providing the user of the terminal apparatus with a management service for the home appliance.

In operation 510, the DRFM 345 may receive the advertised information from the home appliances 150. The advertised information may be transmitted from the home appliances 150 to the DRFM 345 via the router 140.

In operation 515, the DRFM 345 may identify the received advertised information. The DRFM 345 may identify the received advertised information, thereby identifying the home appliances 150 having transmitted the advertised information. The DRFM 345 may select at least one home appliance of which more detailed information is to be received, from among the home appliances 150 based on the received advertised information.

The advertised information may correspond to metadata of an XML format.

The DMPM 350 may extract, from the advertised information, service information related to functions and/or features of the home appliances 150 having transmitted the advertised information. The DMPM 350 may extract URLs and/or model names of the home appliances 150 from the advertised information.

The extracted information may be stored in the data temporary memory 360.

The information stored in the data temporary memory 360 may be utilized by the DSFM 335 to extract detailed information on the home appliances 150. Based on the extracted information, the DSFM 335 may request metadata including detailed information associated with the home appliances 150.

In operation 520, the DSFM 335 may transmit a metadata request signal to the one or more home appliances 150, based on the advertised information. The metadata request signal may correspond to a signal requesting more detailed information on an home appliance associated with basic information included in the advertised information.

In operation 525, the DSFM 335 may receive metadata associated with the home appliances 150 from the home appliances 150.

The DSFM 335 may access the home appliances 150 based on the received advertised information. The DSFM 335 may access the home appliances 150 to receive the metadata associated with the home appliances 150 from the home appliances 150.

The metadata received by the DSFM 335 may be transmitted from the home appliances 150 based on the metadata request signal transmitted by the DSFM 335 to the home appliances 150.

When the home appliances 150 receive the metadata request signal from the DSFM 335, the home appliances 150 may transmit, to the DSFM 335, metadata including at least one piece of state information on a state of each of the home appliances 150, service information related to a function of each home appliance, and information on a command code requested to control each home appliance.

In operation 530, the DMPM 350 may extract, from the metadata received by the DSFM 335, at least one piece of the state information on the states of the home appliances, the service information related to the functions of the home appliances 150, and the information on the command code requested to control the home appliances 150.

In operation 532, the data temporary memory 360 may store the extracted information.

The information stored in the data temporary memory 360 may be utilized when a control signal to controlling a function or an operation of a home appliance is transmitted to the home appliances 150.

In operation 535, the NBM 330 may transfer the metadata received from the home appliances 150 to the NBM 240 of the data server 110. The NBM 330 may transfer, to the data server 110, the metadata received from the home appliances 150 using HTTP. The metadata transferred to the data server 110 may include the information extracted by the DMPM 350.

The NBM 240 may receive the metadata associated with the home appliances 150 from the NBM 330.

When the NBM 240 receives the metadata, the MEM 250 may analyze the received metadata.

In operation 540, the MEM 250 may extract detailed information from the metadata received by the NBM 240.

In operation 542, the detailed information extracted by the MEM 250 from the metadata may be stored in the cloud storage 230.

The MEM 250 may classify the received metadata based on fields. For example, the MEM 250 may classify the received metadata based on at least one field of a model name, a model URL, a device type, a friendly name, a model description, a service description, and an action description of a home appliance.

The classified metadata may be stored in the HDFS of the cloud storage 230 using MapReduce. The classified metadata may be used for providing the user of the terminal apparatus 160 with a monitoring service for home appliances.

In operation 545, the MEM 245 may receive, from the terminal apparatus 160, a request signal with respect to the metadata received by the NBM 240.

In operation 550, the MSM 245 may select metadata to be transmitted to the terminal apparatus 160 from among the metadata received by the NBM 240, based on the received request signal.

In operation 550, the MSM 245 may transfer the received metadata to the terminal apparatus 160, based on the request signal received from eh terminal apparatus 160. The metadata transferred to the terminal apparatus 160 may correspond to the metadata selected from among the metadata received by the NBM 240 in operation 550. The metadata transferred to the terminal apparatus 160 may include information on states of the home appliances 150 and/or model names of the home appliances 150.

In operation 560, the terminal apparatus 160 may display the states of the home appliances 150 based on the received metadata. For example, the states of the home appliances 150 may be output through a display of the terminal apparatus 160.

The user of the terminal apparatus 160 may monitor the states of the home appliances 150 based on the metadata received by the terminal apparatus 160.

The terminal apparatus 160 may not process operations with respect to the received metadata. The terminal apparatus 160 may simply display information included in the metadata transmitted from the MSM 245, and may not process operations with respect to the received metadata.

The user of the terminal apparatus 160 may control a function or an operation of a home appliance, based on the metadata received by the terminal apparatus 160.

In operation 565, the terminal apparatus 160 may generate a control request signal requesting a control of a function or an operation of at least one of the home appliances 150 based on the received metadata, when the user of the terminal apparatus 160 desires to control the function or the operation of the at least one home appliance.

In operation 570, the terminal apparatus 160 may transmit the generated control request signal. The control request signal may include a command code requesting the control of the function or the operation of the at least one home appliance.

The control request signal transmitted by the terminal apparatus 160 may be received by the MSM 245.

In operation 575, the MSM 245 may generate a control signal to control the function or the operation of the at least one home appliance selected by the user of the terminal apparatus 160 from among the home appliances 150, based on the received control request signal.

The MSM 245 may generate a control signal to control a function or an operation of a home appliance corresponding to the received control request signal, based on the detailed information stored in the cloud storage 230. For example, the generated control signal may include a command code to control the function or the operation of the home appliance selected by the user of the terminal apparatus 160, among command codes to control functions or operations of the home appliances 150 included in the detailed information stored in the cloud storage 230.

The MSM 245 may generate the control signal, by selecting a command code to control the function or the operation of the home appliance selected by the user of the terminal apparatus 160 from among command codes to control functions or operations of the home appliances 150 included in the detailed information stored in the cloud storage 230.

In operation 580, the MSM 245 may transmit the generated control signal to the NBM 330 through NBM 240.

The NBM 330 may transfer the received control signal to the ATM 340.

In operation 585, the ATM 340 may transmit the control signal to at least one home appliance of which a function or an operation is controllable by the control signal, among the home appliances 150. For example, the transmitted control signal may include a command code to control the function or the operation of the at least one home appliance selected by the user of the terminal apparatus 160 from among the home appliances 150.

In operation 590, a home appliance receiving the control signal may perform a function or an operation based on the received control signal. The home appliance may be turned on or off, or may change the function or the operation, based on the received control signal.

For example, the data server 110 may provide the user of the terminal apparatus 160 with a service for monitoring the states of the home appliances 150 and/or a service for controlling functions or operations of the home appliances 150.

Although not shown in the drawings, a home appliance having received a control signal may transmit, to the home gateway 130, an action completion signal to report completion of a control of a function or an operation of the home appliance, after the function or the operation of the home appliance is controlled based on the control signal. The action completion signal received by the home gateway 130 may be transmitted to the data server 110, and the data server 110 may transmit the received action completion signal to the terminal apparatus 160. The user of the terminal apparatus 160 may verify that the function or the operation of the home appliance is controlled, through the received action completion signal received by the terminal apparatus 160.

Hereinafter, an example of providing the user of the terminal apparatus 160 with a management service for a refrigerator or a humidifier when the home appliances 150 includes a refrigerator or a humidifier will be described.

A refrigerator may be divided into a freezer compartment and a refrigerator compartment. In this example, the freezer compartment and the refrigerator compartment may include distinctive sensors which may measure temperature with different criteria. A user of the refrigerator may monitor temperature for the freezer compartment and the refrigerator compartment using the respective sensors.

The sensors of the refrigerator may generate information on expiration date on food stored in the refrigerator.

Depending on food to be stored in the refrigerator, temperature of the refrigerator compartment or the freezer compartment may be adjusted.

Information related to the food stored in the refrigerator and/or temperature of the refrigerator, generated by the sensors of the refrigerator, may be transmitted to the data server 110 via the home gateway 130. When the terminal apparatus 160 received the information from the data server 110, the user of the terminal apparatus 160 may monitor a current state of the refrigerator and control temperature of the refrigerator using the terminal apparatus 160.

In this example, the refrigerator may not process operations with respect to the information generated by the sensors, for example, the information on expiration data on food and/or the information on temperature of the refrigerator. The operations with respect to the information generated by the sensors may be processed by the data server 110.

When the home appliance corresponds to a humidifier, a sensor included in the humidifier may measure a water level of a water tank, and transfer information related to the measured water level to the data server 110 via the home gateway 130. When the terminal apparatus 160 received the information from the data server 110, the user of the terminal apparatus 160 may monitor a current state of the humidifier and control an operation of the humidifier using the terminal apparatus 160.

The descriptions provided with reference to FIGS. 1 and 3 may apply to the foregoing and thus, duplicated descriptions will be omitted for conciseness.

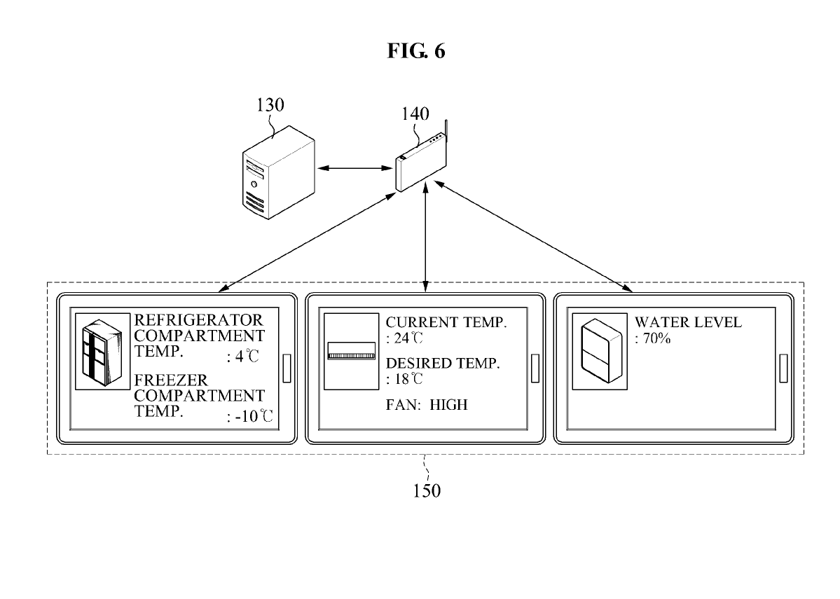

FIG. 6 is a diagram illustrating an example of simulators acting as home appliances.

A system for providing a management service for home appliances according to an embodiment may be implemented using a general-purpose computer and smart devices.

The data server 110 may be a four-node cluster. The data server 110 may store metadata generated by the home appliances 150, and create relevant log files. In order to prevent loss of log data, the data may be stored in the HDFS of the cloud storage 230 of the data server 110.

Hadoop-based MapReduce may be applied to process the data. A Cling library may be used to realize communication with the home network. The Cling library may support UPnP, and may be Java-based. A Java-based platform may be an environment suitable for use of MapReduce.

Cling may provide a UPnP library based on Android. In the system according to an embodiment, simulators acting as home appliances may be used instead of actual home appliances. The simulators may be developed with the Android-based Cling library.

The terminal apparatus 160, for example, a smart device, may be implemented to be used at any place in which an Internet connection is available. The user of the smart device 160 may access the data server 110 using the smart device 160 to monitor and control the home appliances 150 at any place in which an Internet connection is available.

Table 1 lists specifications of components of the system for providing a management service for home appliances according to an embodiment.

TABLE 1

| | | | Simulators | |
|---|---|---|---|---|
| | | Home | (Home | |
| Content | Data Server | Gateway | Appliances) | Smart Device |
| CPU | 2.53 GHz | 2.9 GHz | 1.4 GHz | 1 GHz |
| | Dual-Core | Quad-Core | Quad-Core | Dual-Core |
| RAM | 2 GB | 2 GB | 2 GB | 2 GB |
| Hard Disk | 300 GB | 150 GB | 16 GB | 16 GB |
| OS | Ubuntu | Ubuntu | Android 4.1 | Android 4.0 |
| Libraries | Hadoop, Cling | Cling | Cling | Android API |

All components, except for the smart device 160, may be implemented using the Java-based Cling library. The simulators may be implemented to act as the home appliances 150 such as a refrigerator, a humidifier, and an air conditioner. The simulators may include a tablet PC.

The simulators may correspond to a refrigerator, an air conditioner, and a humidifier.

For example, the simulator corresponding to the refrigerator may display temperature of a refrigerator compartment and temperature of a freezer compartment. The simulator corresponding to the air conditioner may display current room temperature, desired temperature, and a fan setting of the air conditioner. The simulator corresponding to the humidifier may display a water level of a water tank of the humidifier.

When a connection is established between the home gateway 130 and the data server 110, data associated with the home appliances 150 may be transmitted to be stored in the HDFS of the data server 110.

The stored data may be transferred to the smart device 160 of the user by the MSM 245 of the data server 110. Using the data transmitted by the MSM 245, the user of the smart device 160 may identify information related to states of the home appliances 150 and control functions or operations of the home appliances 150.

In order to implement the home appliance simulators, an application programming interface (API) provide by the Cling library may be used.

Table 2 lists classes and functions provided by the API.

TABLE 2

| Class Names | Functions |
|---|---|
| Device | Generates features of home appliances |
| Service | Generates service information of home appliances |
| UDN | Generates UUID |
| DeviceDetails | Used to advertise features of home appliances |
| AnnotationLocal | Binds service information provided by home |
| ServiceBinder | appliances |
| Registry | Registers features and service information of home |
| | appliances |
| SwitchableRouter | Used to connect home appliances to home network |

The home gateway 130 may collect information related to the home appliances 150, for example, information related to at least one of features, functions, and states of the home appliances 150. The home gateway 130 may transmit the collected information to the data server 110. The home gateway 130 may allow the user of the smart device 160 to control the home appliances 150 by means of command codes transmitted by the data server 110 to the home appliances 150.

Table 3 lists APIs used to collect information related to the home appliances 150.

TABLE 3

| Class Names | Functions |
|---|---|
| Device | Generates features of home appliances |
| Service | Generates service information of home appliances |
| UDN | Generates UUID |
| Registry | Registers features and service information of home |
| | appliances |
| SwitchableRouter | Used to connect home appliances to home network |
| RegistryListner | Used to collect information related to home |
| | appliances |
| ActionCallback | Used to transmit control signal to control home |
| | appliances |
| Subscription | Requires detailed service information on home |
| Callback | appliances |
| ActionArgument | Acquires detailed service functions |
| GENASubscription | Periodically requires state information of home |
| | appliances |

The home gateway 130 may transmit state information of the home appliances 150 to the data server 110. The home gateway 130 may include a Cling-based bridge to transmit the state information of the home appliances 150 to the data server 110. The Cling-based bridge may enable the home gateway 130 to communicate with the data server 110. The Cling-based bridge may correspond to the NBM 330 described with reference to FIG. 3.

Table 4 lists main APIs used for implementing the NBM 330.

TABLE 4

| Class Names | Functions |
|---|---|
| BridgeStartedEvent | Used to start WAN bridge |
| BridgeStoppedEvent | Used to stop WAN bridge |
| ConfigureBridgeController | Configures HTTP-based address |
| EndpointController | Used to connect NBM with endpoint |
| Bridge | Used for acquiring communication |
| | arguments |

Table 5 lists APIs used for storing metadata in the HDFS of the cloud storage 230 used by the data server 110. The APIs shown in Table 5 may include APIs used by MapReduce to extract information from the metadata.

TABLE 5

| Class Names | Functions |
|---|---|
| Configuration | Sets system states |
| Path | Path of files or data directory |
| InputSplit | Splits data stream |
| FileSplit | Splits files |
| GetPath | Returns path of split files |
| FSDataInputStream | Used for storing files in HDFS |

The user of the smart device 160 may control the functions or the operations of the home appliances 150 from outside of a home network using the system according to an embodiment.

The home appliances 150 may form ubiquitous sensor networks via state sensors to be used to identify features of the home appliances 150 and/or service information related to the functions of the home appliances 150.

Based on the identified information related to the home appliances 150, the home gateway 130 may collect metadata from the home appliances 150, and transfer the collected metadata to the data server 110.

The data server 110 may store the metadata in the HDFS of the cloud storage 230, and process the metadata using MapReduce. The data server 110 may provide the user of the smart device 160 with a monitoring service for the home appliances 150. The user of the smart device 160 may control the functions or the operations of the home appliances 150 using the smart device 160.

A management service for the home appliances 150 may be provided using the smart device 160 to the user of the smart device 160, whereby the user may easily monitor or control states of the home appliances 150.

According to exemplary embodiments, a cloud-based data server providing a home appliance management service to a user of a terminal apparatus using a cloud storage, and a method thereof performed by the cloud-based data server may be provided.

According to exemplary embodiments, by providing a home appliance management service to a user of a terminal apparatus through a cloud-based data server, metadata, associated with home appliances, generated by the home appliances may be managed efficiently.

According to exemplary embodiments, a user of a terminal apparatus may remotely control functions or operations of home appliances or monitor states of the home appliances in a home network system using the terminal apparatus.

According to exemplary embodiments, metadata, associated with home appliances, generated by the home appliances may be processed by a cloud-based data server, whereby an amount of resources used by a terminal apparatus may be reduced.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a home appliance management service, the method performed by a cloud-based data server providing a user of a terminal apparatus with a management service for one or more home appliances connected to a home gateway through a home network using a cloud storage, the method comprising:
receiving metadata associated with the one or more home appliances from the home gateway;
receiving a request signal with respect to the received metadata from the terminal apparatus; and
transmitting the received metadata to the terminal apparatus based on the request signal.

2. The method of claim 1, further comprising:
receiving, from the terminal apparatus, a control request signal corresponding to a signal requesting control of a function or an operation of at least one of the one or more home appliances; and
transmitting, to the home gateway, a control signal to control the function or the operation of the at least one home appliance based on the received control request signal.

3. The method of claim 2, wherein the control signal comprises a command code controlling the function or the operation of the at least one home appliance.

4. The method of claim 1, wherein the metadata comprises at least one piece of state information on a state of each of the one or more home appliances, service information related to a function of each of the one or more home appliances, and information on a command code requested to control each of the one or more home appliances.

5. The method of claim 1, further comprising:
selecting metadata to be transmitted to the terminal apparatus from among the received metadata, based on the received request signal,
wherein the transmitting comprises transmitting the selected metadata to the terminal apparatus.

6. The method of claim 1, further comprising:
extracting detailed information from the received metadata; and
storing the extracted detailed information in the cloud storage.

7. The method of claim 6, wherein the extracting comprises extracting the detailed information from the metadata by extracting values of each metadata field, and
metadata to be transmitted to the terminal apparatus comprises information selected based on the request signal from among the extracted detailed information.

8. A non-transitory computer-readable medium comprising a program for instructing a computer to perform the method of claim 1.

9. A method of managing a home appliance, the method performed by a home gateway connected to one or more home appliances through a home network, the method comprising:
receiving metadata associated with the one or more home appliances from the one or more home appliances;
transmitting the received metadata to a cloud-based data server;
receiving, from the cloud-based data server, a control signal corresponding to a signal controlling a function or an operation of at least one of the one or more home appliances; and
transmitting the received control signal to the at least one home appliance.

10. The method of claim 9, further comprising:
receiving advertised information from the one or more home appliances; and
transmitting a metadata request signal to the one or more home appliances based on the advertised information,
wherein the receiving of the metadata comprises receiving metadata transmitted based on the metadata request signal from the one or more home appliances.

11. The method of claim 9, wherein the receiving of the metadata comprises accessing the one or more home appliances to receive the metadata associated with the one or more home appliances from the one or more home appliances.

12. The method of claim 9, wherein the one or more home appliances are connected to the home gateway via a router.

13. The method of claim 9, wherein the metadata comprises at least one piece of state information on a state of each of the one or more home appliances, service information related to a function of each of the one or more home appliances, and information on a command code requested to control each of the one or more home appliances.

14. The method of claim 9, wherein the control signal comprises a command code controlling the function or the operation of the at least one home appliance.

15. A non-transitory computer-readable medium comprising a program for instructing a computer to perform the method of claim 9.

16. A cloud-based data server providing a user of a terminal apparatus with a management service for one or more home appliances connected to a home gateway through a home network using a cloud storage, the data server comprising:
a network bridge module (NBM) to receive metadata associated with the one or more home appliances from the home gateway; and
a monitoring service module (MSM) to receive a request signal with respect to the metadata from the terminal apparatus, and transmit the received metadata to the terminal apparatus based on the request signal.

17. The data server of claim 16, wherein the MSM receives, from the terminal apparatus, a control request signal corresponding to a signal requesting control of a function or an operation of at least one of the one or more home appliances, and transmits, to the home gateway, a control signal to control the function or the operation of the at least one home appliance based on the received control request signal.

18. The data server of claim 16, further comprising:
a metadata extraction module (MEM) to extract detailed information from the received metadata,
wherein the extracted detailed information is stored in the cloud storage.

19. A home gateway connected to one or more home appliances through a home network, the home gateway comprising:
a device subscription function module (DSFM) to receive metadata associated with the one or more home appliances from the one or more home appliances;
a network bridge module (NBM) to transmit the received metadata to a cloud-based data server, and receive a control signal from the cloud-based data server; and
an action transmission module (ATM) to transmit the received control signal to at least one of the one or more home appliances,
wherein the control signal corresponds to a signal controlling a function or an operation of the at least one home appliance.

20. The home gateway of claim 19, further comprising:
a device registering function module (DRFM) to receive advertised information from the one or more home appliances,
wherein the DSFM transmits a metadata request signal to the one or more home appliances based on the advertised information, and receives metadata transmitted based on the metadata request signal from the one or more home appliances.
